(19) United States
(12) Patent Application Publication
(10) Pub. No.: US 2014/0238201 A1
(43) Pub. Date: Aug. 28, 2014

(54) LIGHTWEIGHT, STRONG HAMMER

(71) Applicant: Gary Pimentel, Vista, CA (US)

(72) Inventor: Gary Pimentel, Vista, CA (US)

(21) Appl. No.: 14/192,596

(22) Filed: Feb. 27, 2014

Related U.S. Application Data
(60) Provisional application No. 61/770,259, filed on Feb. 27, 2013.

(51) Int. Cl. B25D 1/06; B25D 1/02

(52) U.S. Cl. CPC B25D 1/06; B25D 1/02
USPC 81/24; 81/25

(57) ABSTRACT

A lightweight, strong hammer. A hollow lightweight aluminum handle is connected to a hammer head. A spring face piece is removably attached to said hammer head. In a preferred embodiment, the spring face piece has a spring face that is welded to a hollow threaded hammer poll. In one preferred embodiment, the hollow lightweight aluminum handle has a contoured shape. In another preferred embodiment the hollow lightweight aluminum handle has a straight shape.

The present invention relates to tools, and in particular, to striking tools, such as hammers. This application claims the benefit of U.S. Provisional Application Ser. No. 61/770,259, filed on Feb. 27, 2013, which is incorporated by reference herein.

### BACKGROUND OF THE INVENTION

FIG. 9C shows prior art hammer 1. A typical framing hammer, such as hammer 1, is composed of 2 basic parts: the head and the handle. A typical head is either cast of forged with 6 basic features: Face, Poll, Neck, Cheek, Eye and Claw. To complete the hammer assembly, the top portion of the hammer head is glued and then pressed into the eye of the head. Wedges are then driven into the top of the handle, expanding it into the eye for a snug fit.

What is needed is a better lightweight, strong hammer.

### SUMMARY OF THE INVENTION

The present invention provides a lightweight, strong hammer. A hollow lightweight aluminum handle is connected to a hammer head. A spring face piece is removably attached to said hammer head. In a preferred embodiment, the spring face piece has a spring face that is welded to a hollow threaded hammer poll. In one preferred embodiment, the hollow lightweight aluminum handle has a contoured shape. In another preferred embodiment the hollow lightweight aluminum handle has a straight shape.

### BRIEF DESCRIPTION OF THE DRAWINGS

FIGS. 1-2 show a preferred embodiment of the present invention.

FIGS. 3-4 show a preferred spring face piece.

FIG. 5 shows a preferred handle.

FIG. 6 shows a preferred hammer head.

FIGS. 7-9 show a preferred handle.

FIG. 9B shows a preferred removable ring with magnet.

FIG. 9C shows a prior art hammer.

FIGS. 10A-10B show a preferred method of attaching a hammer head.

FIGS. 11-12 show another preferred embodiment of the present invention.

FIGS. 13-14 show a preferred method of attaching a spring face piece.

FIGS. 15-18 shows preferred handles.

### DETAILED DESCRIPTION OF THE PREFERRED EMBODIMENTS

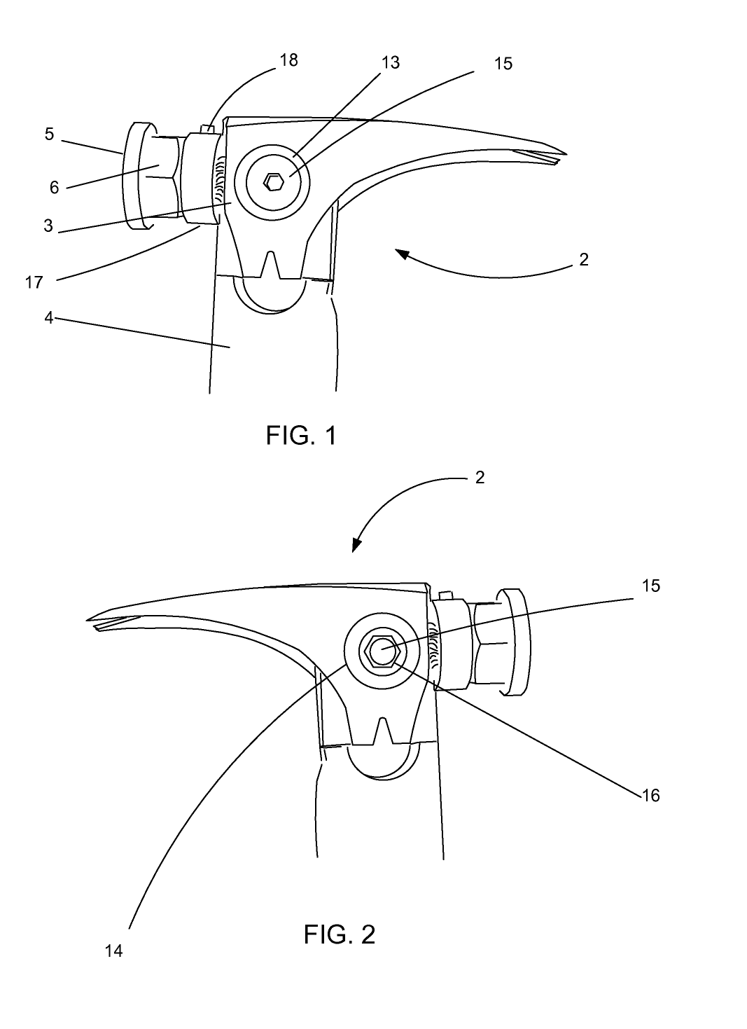

FIGS. 1 and 2 show left and right side views of preferred hammer 2. When the overall swing weight of a framing hammer is reduced to a range of 25-27 ounces using a lightweight fabricated steel head 3 combined with a stiff, strong, lightweight hollow body aluminum hammer handle 4; more work can be produced with less effort and fatigue to the user. A light weight hammer is easer to accelerate: therefore achieving a higher velocity at impact. A stiff, strong, lightweight aluminum hollow body handle does not transmit shock and vibration the same way a wood, steel or fiberglass handle does, because it has a much higher natural frequency. It does not resonate at the same low frequencies that are created when impacting a nail or when the hammer's face hits a solid body. Furthermore, Applicant has determined that if face 5 is made of a thin ultra height strength material and is attached to a hollow poll 6, thin walled face 5 can act as a spring, storing and releasing energy. This type of collision is called an elastic collision. Research has proven that an elastic collision can transmit kinetic energy more efficiently with less shock and vibration compared to a prior art hammer that utilizes an inelastic collision.

### Hammer Head

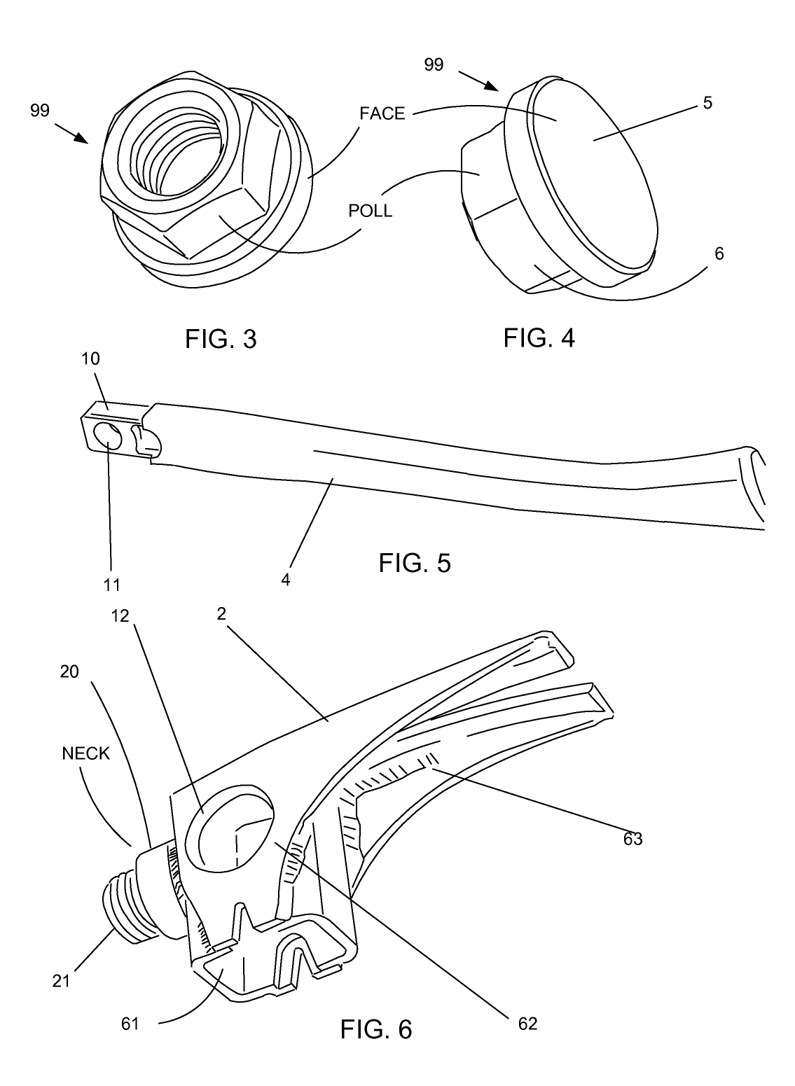

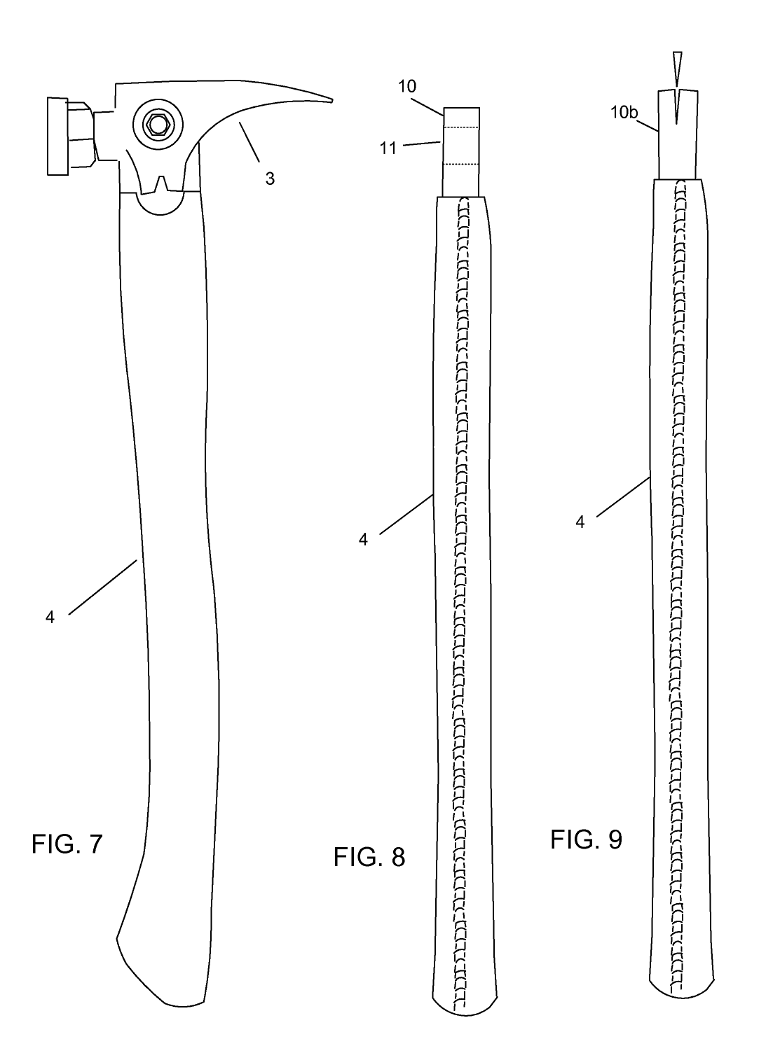

FIG. 6 shows a perspective view and FIG. 7 shows a side view of preferred hammer head 3. By using modern day high strength steels (60-200) KSI, hammer head 3 can be constructed in such a fashion to achieve an optimum weight of 13-14 oz. By constructing eye 61, cheek 62 and claw 63 from 0.125 inch thick steel plate and constructing a hollow poll 6 (FIGS. 1, 3 and 4) and neck 20 of 0.080 inch wall thickness, and constructing the face (see FIGS. 3 and 4) from 0.100 inch steel, a 13.5 ounce head is can be constructed.

There are many advantages to this construction technique:

1) No major capital investment in forging of investment casting tools.

2) A composite of parts made from different material can be joined to give the head overall better performance, durability and corrosion resistance.

3) Materials that are not easily cast or forged can be can be used.

4) Materials that are cast or forged rarely exhibit the same mechanical properties of plate stock of the same alloy, because of porosity and impurities introduced by the casting process.

5) Parts made from plate can be produced very cost effectively, by using a nested group and cut with modern CNC Water Jet or Laser cutting techniques.

6) Round parts can produce very cost effectively using Bar Stock or Tubing and processed on modern CNC turning equipment.

7) Many different types of hammers can be made with the same equipment with out any major retooling required.

### Handle

A critical component to reduce shock and vibration of a hammer is the handle. A preferred contoured handle 4 is shown in FIGS. 5. Handle 4 is contoured because its cross section shape and area varies along its length. Cross section analysis has shown that a hollow body 6061 T6 Aluminum handle, having varying elliptical cross sections is optimum for constructing a handle that is very stiff, strong and light weight. Many samples were constructed and tested. In a preferred embodiment, the thickness of the aluminum for handle 4 is approximately 0.080 inch thick.

### Formation of the Handle

Stiff, strong light weight, hollow body aluminum hammer handle 4 can be formed by two convenient methods. In a first method a tube is expanded with hydraulic pressure into a split female cavity mold. The mold is held in a ridged press, the top and bottom are held together with positive location and the two halves are opened. The tube is place into the cavity mold and the mold is closed. Hydraulic pressure is the applied to the inside of the tube by means of specially designed fittings that can contain the applied pressure with specially designed seals. Hydraulic pressure is applied to the inside of the tube forcing the tube to expand and take the shape of the female mold. Pressure is relieved, the press is opened and the formed part is removed.

Utilizing another method, a stiff strong light weight, hollow body aluminum hammer handle can be formed in tow concentric shells and then seam welded. Two male dies of appropriate shape and cross section and material can be constructed. The dies can then be place in a ridged press, equipped with a containment box that holds a bed of durable rubber. A pre determined aluminum blank is cut and held with positive location on the part and then the press is closed with enough force to force the rubber to form the aluminum against the die. The press is then opened and the two parts can be removed. The two parts 71 and 72 can then be joined together by weld 73 (FIG. 8).

The method that is used to attach handle 4 is important. It is imperative that the stress created sticking or impacting that is transmitted into handle 4 is done in such a way that the yield strength of the material is not exceed.

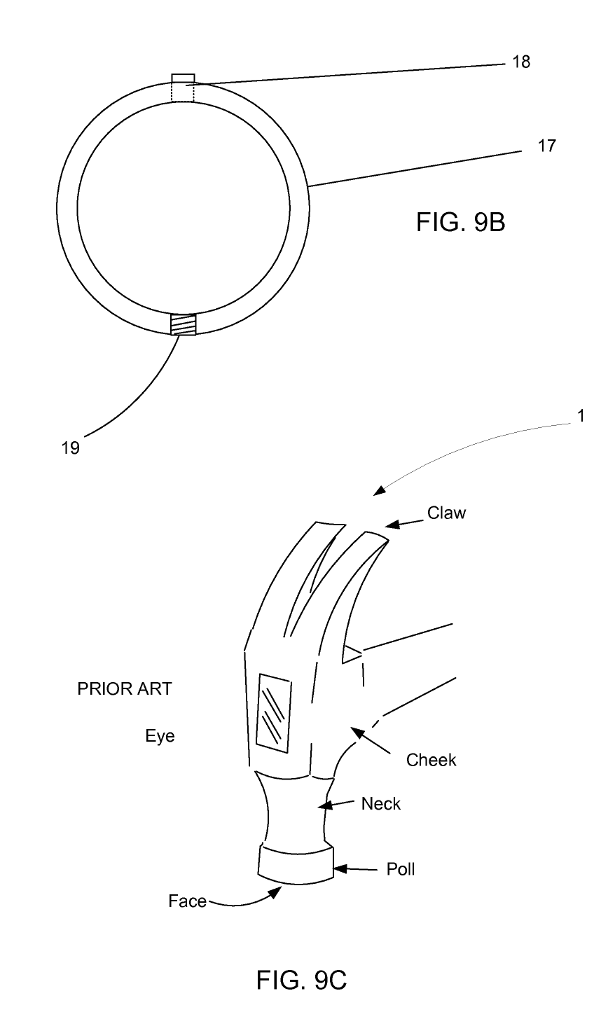

Two configurations have been developed and tested with good results. The first is a permanent wedge lock mechanism shown in FIG. 9. Wedge 81 inserts into extension 10b to lock head 3 to handle 4. The second method uses a system of bushings a nut and bolt to lock the system together (FIGS. 1-2). They both have advantages. The first system is lighter and cheaper to build and the second allows for a convenient method of disassemble and interchangeability.

### Preferred Method of Connecting the Head to the Handle

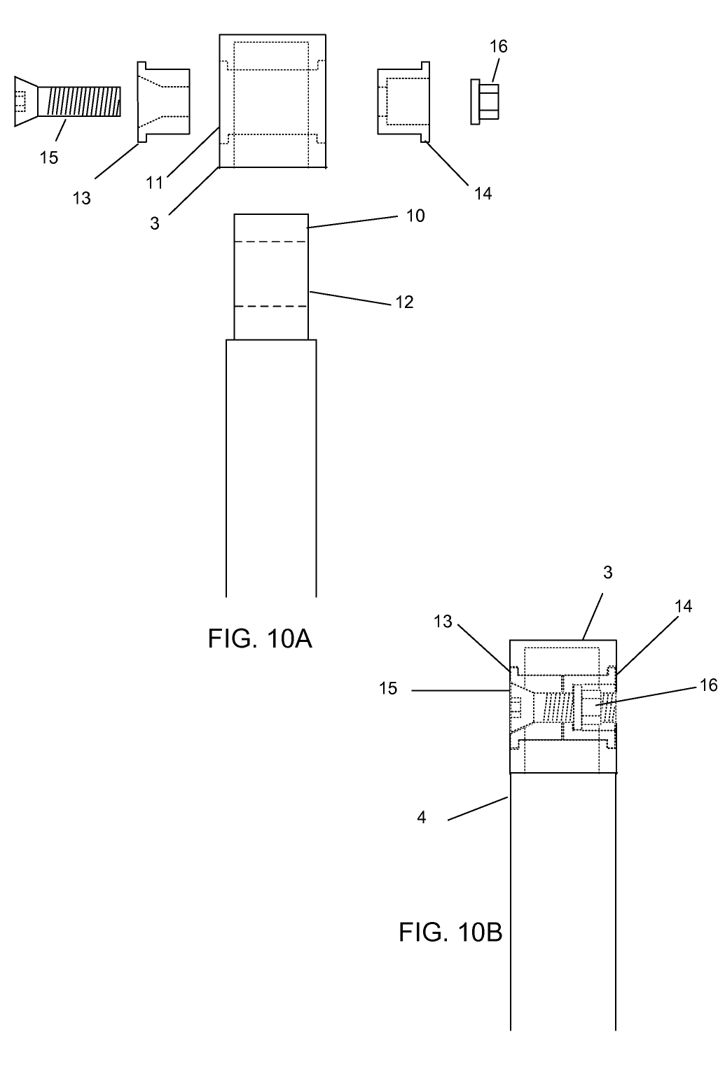

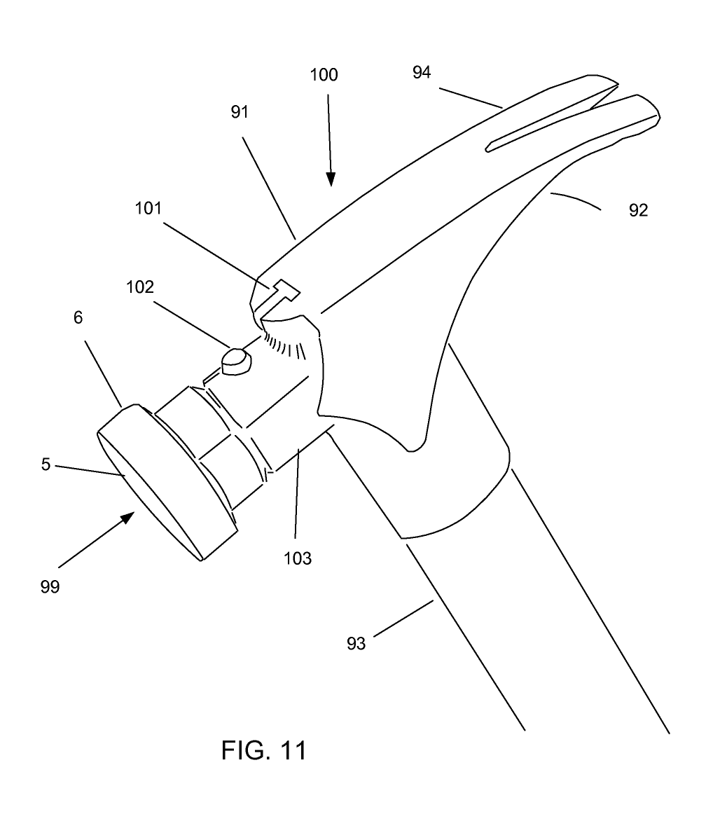

As shown in FIGS. 10A-10B, handle 4 includes solid aluminum extension 10 having hole 11. To attach head 2, head 2 is slid over extension 10 so that hole 12 and hole 11 are aligned. Bushings 13 and 14 are then inserted into the holes. Bolt 15 is then inserted through the bushings and secured with nut 16. Removable ring 17 having nail magnet 18 (FIG. 1) is then slid over neck 20 and secured by using an allen wrench to tighten hex screw 19 (FIG. 9B). As shown in FIGS. 3 and 4, removable spring face piece 99 includes face 5 that is attached to threaded poll 6 via a permanent weld. Threaded poll 6 is then tightened onto threads 21 (FIG. 6) extending from neck 20. FIGS. 1 and 2 show a preferred assembled handle and head with the above preferred parts described.

Advantages of a stiff, light weight hollow body hammer handle 4:

1) Consistent mechanical properties. Wood or cellulous fiber mechanical properties very do to many variables: like species, water content and age.

2) Cellulous fiber breaks down and becomes flexible after repeated blow. Aluminum remains stiff thought its entire service life.

3) Wood handles transmit shock and vibration at much lower frequency that contribute to fatigue and repetitive motion syndrome.

4) Aluminum handles can be made stronger, lighter and more durable than a wood handle.

5) Aluminum handles can be made with a detachable interlock device.

6) Aluminum handles can be tuned by varying the shape cross section and thickness to achieve different design parameters.

### Other Preferred Embodiment

FIGS. 11-18 show another preferred embodiment of the present invention.

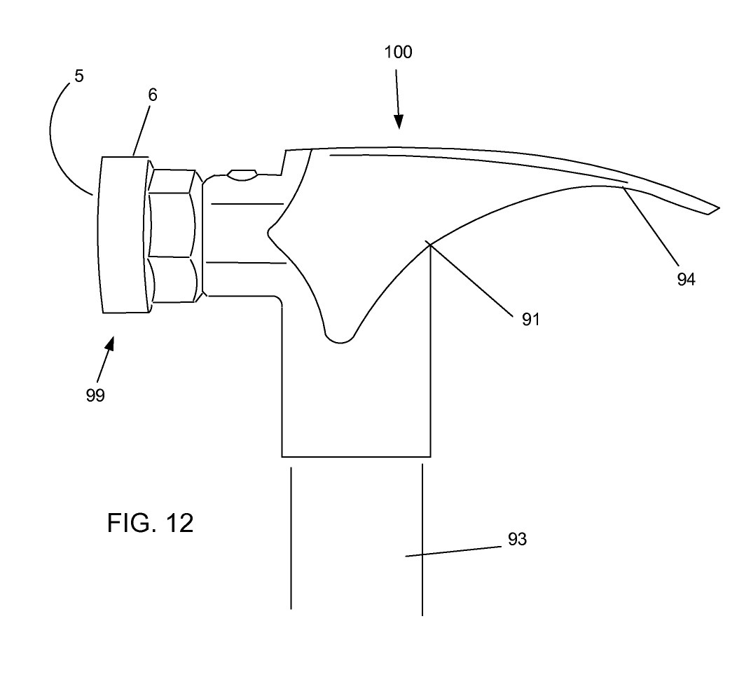

FIG. 11 shows a perspective view and FIG. 12 shows a side view of hammer 100. Head 91 is attached to handle 93. In a preferred embodiment, handle 93 is press fit into head 91. Head 91 includes spring face piece 99 with hollow poll 6 and thin walled spring-face 5. Spring face 5 acts as a spring in that it stores and releases energy in a fashion similar to that described above. In a preferred embodiment head 91 and claw 94 is fabricated from 4130 chromoly steel. Spring face piece 99 is fabricated from 17-4 stainless steel.

Nail holder 101 is cut in the shape of a “T” into the top of head 91. A nail head is placed into nail holder 101 and the nail is further held in place by magnet 102 that is press fit into neck

### Connecting the Spring Face Piece to the Head

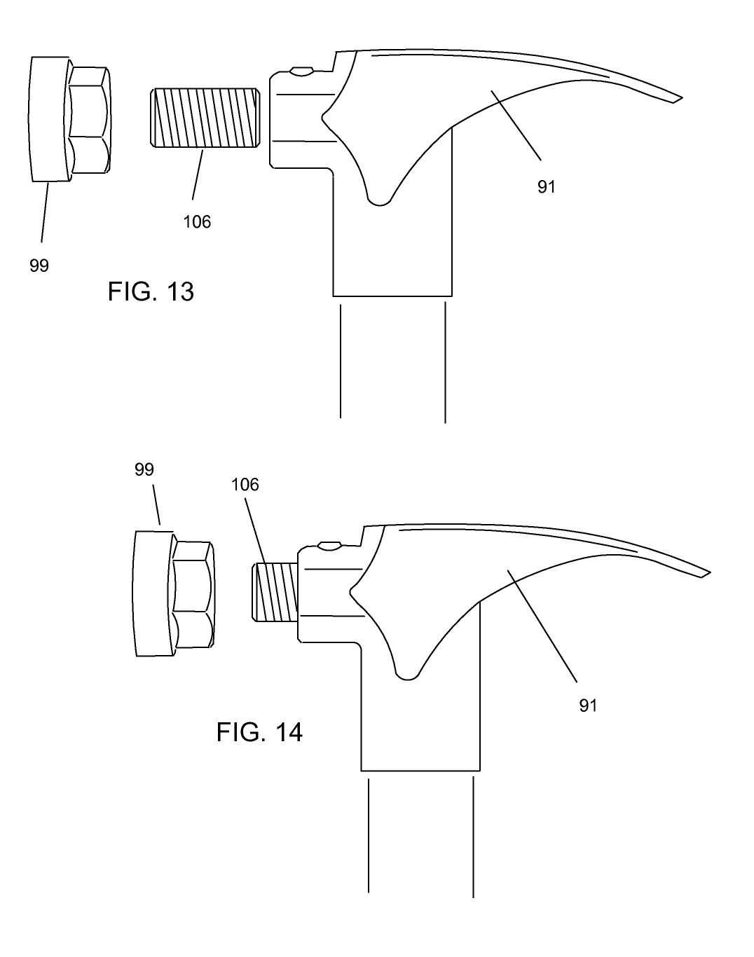

FIGS. 13 and 14 show a preferred method of connecting spring face piece 99 to head 91. Bolt 106 is threaded into head 91 (FIG. 14). Then spring face piece 99 is threaded onto bolt 106 so that hammer 100 appears as shown in FIGS. 11 and 12.

### Preferred Handle

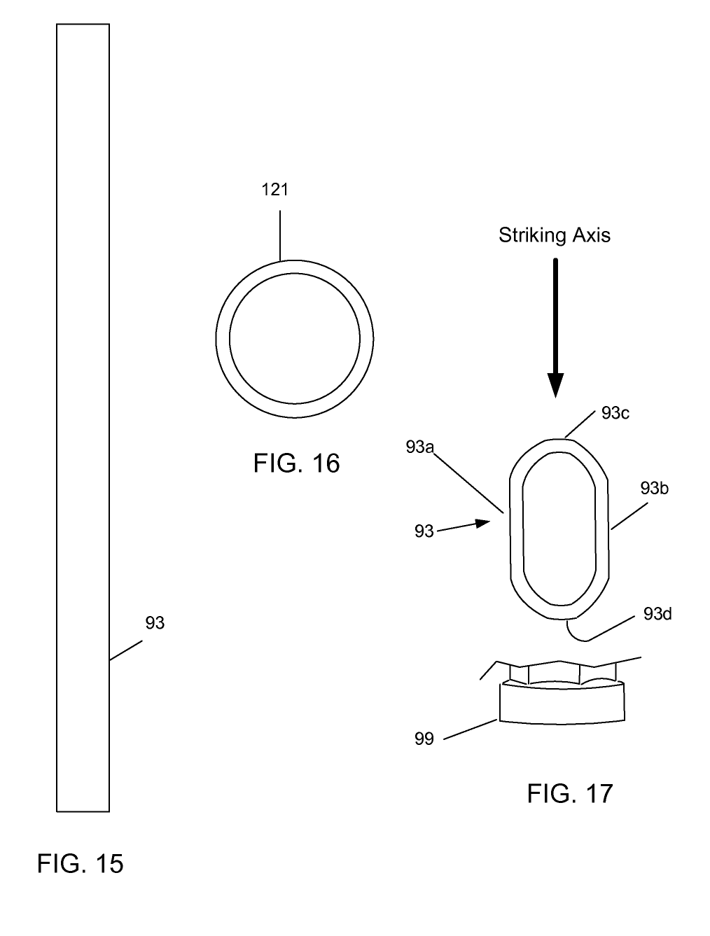

FIG. 15 shows a top view of handle 93. Handle 93 is a lightweight, hollow, aluminum handle that has a cross section that remains constant throughout its length, so that its cross section area and shape does not vary. For example, FIG. 17 shows a rear end view of handle 93. The shell of aluminum handle 93 is approximately ⅛ inch thick.

In a preferred embodiment handle 93 includes parallel sides 93a and 93b and has rounded top 94c and rounded bottom 94d. Spring face piece 99 is facing downward. The striking axis is shown in FIG. 17. Parallel sides run parallel to the striking axis for extra strength and durability.

In one preferred embodiment handle 93 is fabricated by extruding the handle in the shape shown in FIG. 17 and then cutting the handle at the desired length. In another preferred embodiment, handle 93 is fabricated by obtaining round aluminum tubing 121 (FIG. 16). The tubing is then placed between two rollers and compressed until it is flattened into the shape shown in FIG. 17.

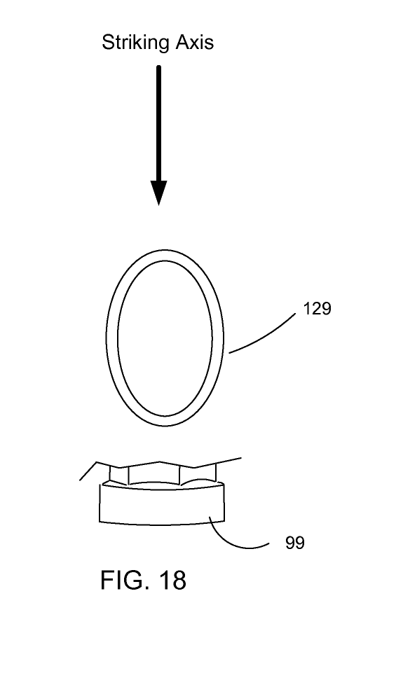

FIG. 18 shows handle 129 that has been extruded so that it is in the shape of a true ellipse. The major axis of the elliptical handle 129 runs parallel to the striking axis for extra strength and durability.

A major advantage of hammer 100 is that handle 93 can very simple made via an extrusion process. It is then press fit into head 91. This greatly simplifies the fabrication process of hammer 100 and drastically reduces the cost to produce. For example, Applicant estimates that hammer 100 can be manufactured for less than approximately $13.00. Hammer 100 is therefore desirable because it is extremely strong, it is very light and it is very inexpensive.

While the present invention has been described in terms of preferred embodiments, the reader should consider these described embodiments only as particular embodiments. Many other embodiments are possible. Therefore, the reader should determine the scope of the present invention by the claims and their legal equivalents.

What is claimed is:

1. A lightweight, strong hammer, comprising:
A. a hollow aluminum hammer handle,
B. a hammer head connected to said hammer handle, and
C. a removably attached spring face piece.

2. The hammer as in claim 1, wherein said hollow aluminum hammer handle is contoured hammer handle with a varying cross sectional areas along its longitudinal axis.

3. The hammer as in claim 1, wherein said hollow aluminum hammer handle is a straight hammer handle with constant cross sectional areas along its longitudinal axis.

4. The hammer as in claim 3, wherein said hollow aluminum handle is an extruded hammer handle.

5. The hammer as in claim 3, wherein said hollow aluminum handle comprises two parallel sides that are parallel with said hammers striking axis.

6. The hammer as in claim 3, wherein said hollow aluminum handle is flattened between rollers so that said hollow aluminum handle comprises two parallel sides that are parallel with said hammers striking axis.

7. The hammer as in claim 3, wherein said hollow aluminum handle comprises and elliptical cross section.

8. The hammer as in claim 1, wherein said hammer head is press fit onto said handle.

9. The hammer as in claim 1 wherein said hammer head is removable attached to said handle.

10. The hammer as in claim 9, wherein said handle comprises an extension piece, wherein said hammer further comprises:
A. two bushings,
B. a bolt, and
C. a nut, wherein said bolt extends through said hammer head, said extension piece, said two bushings and is tightened with said nut.

11. The hammer as in claim 1 further comprising:
A. a removable ring,
B. a magnet connected to said removable ring, and
C. a tightening mechanism, wherein said tightening mechanism is utilized to tighten said removable ring to said hammer head, wherein said magnet is utilized to hold a nail in place on said hammer head.

12. The hammer as in claim 1, wherein said hammer head further comprises a T-slot and a magnet for hold a nail in place on said hammer head.

13. The hammer as in claim 1, further comprising a removably attached bolt for bolting said spring face piece onto said hammer head.

14. The hammer as in claim 1, wherein said handle is press fit into said hammer head, wherein said hammer head further comprises a T-slot and a magnet for holding a nail in place on said hammer head, wherein said hammer head further comprises a removably attached bolt for bolting said spring face piece onto said hammer head, wherein said hollow aluminum hammer handle is a straight hammer handle with constant cross sectional areas along its longitudinal axis, and wherein said hollow aluminum handle comprises two parallel sides that are parallel with said hammer's striking axis.
